(19) United States
(12) Patent Application Publication
(10) Pub. No.: US 2023/0143767 A1
(43) Pub. Date: May 11, 2023

(54) COMPUTER ENHANCED SAFETY SYSTEM

(71) Applicant: SANDVIK LTD, Dungannon (GB)

(72) Inventors: Patrick FORREST, Tyrone (GB); Stuart GRAYDON, Tyrone (GB)

(21) Appl. No.: 17/909,144

(22) PCT Filed: Mar. 6, 2020
(86) PCT No.: PCT/EP2020/056044

§ 371 Date: Sep. 2, 2022

(51) Int. Cl. F16P 3/14; G06V 20/20; G06T 11/00; G06K 7/14

(52) U.S. Cl. CPC F16P 3/142; G06V 20/20; G06T 11/00; G06K 7/1413; G06K 7/1417; G06F 3/017

(57) ABSTRACT

A device for assisting with the safe use of a machine. The device has a user interface for displaying an augmented reality scene, a camera for capturing, in real time, video of an area of interest for inclusion in an augmented reality scene, a positioning module for determining the position of the device relative to the machine, a shape recognition module for recognizing an actual location near the machine in the video, a database of virtual safe areas around the machine, which are displayable in the augmented reality scene and a matching module for matching the virtual safe areas to the corresponding actual component, to identify to a user, in the augmented reality scene, areas around the machine which are safe and corresponding areas which are unsafe. A library of signs, arrows and the like, which are displayable and represent hazards, prohibitions and mandatory actions to the user, are available.

### FIELD OF THE INVENTION

The invention relates to a device and method for assisting with the safe use of work machines such as mobile stone crushers and screeners and in particular to safe movement on or around work machines.

### BACKGROUND TO THE INVENTION

A crusher is a machine designed to reduce large rocks into smaller rocks, gravel, or rock dust. Crushers may be used to reduce the size, or change the form, of waste materials so they can be more easily disposed of or recycled, or to reduce the size of a solid mix of raw materials (as in rock ore), so that pieces of different composition can be differentiated.

Mining, quarrying demolition and recycling operations use crushers, commonly classified by the degree to which they fragment the starting material, with primary and secondary crushers handling coarse materials, and tertiary and quaternary crushers reducing ore particles to finer gradations. Each crusher is designed to work with a certain maximum size of raw material, and often delivers its output to a screening machine which sorts and directs the product for further processing.

FIG. 1a is a first side view of a crusher, FIG. 1b is a second side view of the crusher and FIG. 1c is a plan view of the crusher. In these figures, the crusher 1 is shown to comprise a hopper 3 for receiving unprocessed rocks, a crusher box 5 where the rocks are crushed, a side conveyor 7 a hydraulic control box 9, a main conveyor 11, a power pack 13, an electrical control box 15, hopper doors 17 and tracks 19. The non-drive side 21 and drive side 23 are shown in FIG. 1c. A variant can include a screen in between the feed conveyor and the crusher. In addition, the machines may be powered using diesel/hydraulic systems or diesel/electric systems.

FIG. 2 is a perspective view of a similar crusher in which the following features are shown. A chassis with tracks, hydraulic tank, feeder conveyor, legs, control cabinets, main output conveyor, drive guard and belt tensioning system, cone crusher and feed box, maintenance walkway, cone lubrication tank, power pack and hopper.

Machines such as the crushers illustrated in FIGS. 1a-c and 2, are complex, expensive and are built with high quality components made from high specification materials to allow the components to withstand harsh environments at extreme temperatures and weather conditions and where a significant amount of dust and rock particulates are in the local environment.

As is apparent from FIGS. 1a to 1c and 2, work machines of this type and others represent a potentially hazardous environment and they are designed and manufactured to comply with EU and international standards covering health and safety.

Risks include:
1. Breathing or inhalation of dust particles;
2. Electric shock;
3. Crushing;
4. Entanglement;
5. Falling material;
6. Noise and others.

In general, hazards are shown by a black symbol inside a yellow triangle with a black outline. Prohibitions are shown by a black symbol inside a red circle with a diagonal red bar that extends across the black symbol. Mandatory actions are illustrated by a white symbol inside a blue circle. Such symbols are well known and specific examples can be found in machine health and safety manuals. In addition, operator safety features are included, for example:
1. Emergency stop buttons;
2. A variety of safety and warning signs such as;
   a. Do not use equipment when safety guard is absent signs;
   b. Handrail signs;
   c. A general warning to use handrails and tread plates for maintenance access;
   d. Limited access signs; and
   e. No entry signs.

### SUMMARY OF THE INVENTION

In accordance with a first aspect of the invention there is provided a device for assisting with the safe use of a machine, the device comprising:

a user interface for displaying an augmented reality scene;

a camera for capturing in real time, video of an area of interest for inclusion in an augmented reality scene;

a positioning module for determining the position of the device relative to the machine;

a shape recognition module for recognising an actual location near the machine in the video;

a database of virtual safe areas around the machine which are displayable in the augmented reality scene;

a matching module for matching the virtual safe areas to the corresponding actual component, to identify to a user, in the augmented reality scene, areas around the machine which are safe and corresponding areas which are unsafe.

In at least one embodiment of the invention, sensors determine the active status of the machine the safety of a zone is determined depending on whether the zone is in or near an area where the machine is inactive or active.

In at least one embodiment, the machine is paired with the device using a near field communication system that detects the device is in the vicinity of the machine and then instructs the user to look at the machine or scan the reference marker before proceeding.

It will be appreciated that the term Augmented Reality (AR) may be substituted with the term Mixed Reality (MR). Both terms convey the use of technology to provide a user interface that merges real and virtual worlds.

In at least one embodiment, the device is a handheld device.

In at least one embodiment, the handheld device is a tablet computer or smartphone.

In at least one embodiment, the device is an augmented reality headset. The term headset includes but is not limited to, headwear, eyewear and other similar wearable technology.

In at least one embodiment, the user interface is an audio output.

In at least one embodiment, the user interface combines a graphical user interface and an audio output.

In at least one embodiment, the graphical user interface is controlled by physical interaction with the handheld device.

In at least one embodiment, the graphical user interface is controlled by gestures which interact with objects in the augmented reality environment.

In at least one embodiment, the graphical user interface comprises augmented reality video and animation combined with instruction windows.

In at least one embodiment, the positioning module comprises a GPS location device.

In at least one embodiment, the positioning module comprises a local network device which determines the position of the device with respect to nodes in a local network.

In at least one embodiment, the positioning module comprises a combination of GPS and local network.

The local network may comprise (Wi-Fi™, Bluetooth™, mesh network or other) or alternatively connected to the machine's telematics API through an internet connection (GSM, 3G, 4G, 5G).

In at least one embodiment, the positioning module detects and plots the position of the device with respect to the machine.

In at least one embodiment, the positioning module uses a grid/mesh network of gaming objects positioned a set distance away from the machine.

In at least one embodiment, the positioning module defines an area relative to the machine and detects when the device has moved into/out of an area corresponding to a virtual safe area.

In at least one embodiment, the positioning module provides updated device position information to allow the augmented reality scene to reflect a change of location of the device with respect to the machine.

In at least one embodiment, the matching module indicates matching by an alert on the user interface.

In at least one embodiment the alert is a flashing virtual area.

In at least one embodiment, the alert is a change in colour of the virtual area.

In at least one embodiment the alert is a sound.

In at least one embodiment, the machine is a stone crusher.

In at least one embodiment the machine is a screener.

In at least one embodiment, a reference marker is provided at a predetermined location on the machine to orient the device with respect to the machine.

In at least one embodiment, the reference marker is a barcode.

In at least one embodiment, the reference marker is a QR code

In at least one embodiment, the reference marker is scanned and the augmented reality scene is mapped out on the user interface with respect to that reference point.

In at least one embodiment of the present invention, the machine acts as its own independent server to store the augmented reality content required to be displayed on the headwear.

In at least one embodiment of the present invention, a hand held device acts as its own independent server to store the augmented reality content required to be displayed on the headwear.

In at least one embodiment, the device may stop the machine.

In at least one embodiment a plurality of devices may be used in conjunction with a single machine.

In another embodiment multiple machines may be controlled from a single device

In at least one embodiment, at least one of the plurality of devices are provided with location information on the other devices.

In accordance with a second aspect of the invention there is provided a computer implemented method for assisting with the maintenance of machinery, the method comprising the steps of:

capturing, in real time, a video of an area of interest for inclusion in an augmented reality scene, on a user interface of the device;

determining the position of the device relative to a machine;

recognising an actual area near the machine in the video;

accessing a database of virtual safe areas which are displayable in the augmented reality scene;

matching the virtual safe areas to the corresponding actual area to show a user in the augmented reality scene, areas around the machine which are safe and corresponding areas which are unsafe.

In at least one embodiment of the invention, the active status of the machine is detected using sensors and the safety of a zone is determined depending on whether the zone is in or near an area where the machine is inactive or active.

In at least one embodiment, the user interface is a graphical user interface which is controlled by gestures which interact with objects in the augmented reality environment.

In at least one embodiment, the step of determining the position of the device relative to a machine uses GPS.

In at least one embodiment, the step of determining the position of the device relative to a machine determines the position of the device with respect to nodes in a local network.

In at least one embodiment, the step of determining the position of the device relative to a machine combines GPS and the local network.

The local network may comprise (Wi-Fi™, Bluetooth™, mesh network etc) or alternatively connected to the machines telematics API through an internet connection (GSM, 3G, 4G, 5G).

In at least one embodiment, the step of determining the position of the device relative to a machine uses a grid/mesh network of invisible gaming objects positioned a set distance away from the machine.

In at least one embodiment, the step of determining the position of the device relative to a machine defines an area relative to the machine and detects when the device has moved into/out of the area.

In at least one embodiment, an alert is provided to the device if it moves out of the area.

In at least one embodiment, the step of determining the position of the device relative to a machine detects and plots the position of the device with respect to the machine.

In at least one embodiment, the step of determining the position of the device relative to a machine, the device position information is updated to allow the augmented reality scene to reflect a change of location of the device with respect to the machine.

In at least one embodiment, the step of determining the position of the device relative to a machine, the device position information is updated to allow a change in the position of the virtual component with respect to the machine as shown by the video image of the area of interest.

In at least one embodiment, the virtual component is overlaid with an actual component image received from the camera.

In at least one embodiment, matching is indicated by an alert on the user interface.

In at least one embodiment the alert is a flashing virtual area.

In at least one embodiment, the alert is a change in colour of the virtual area.

In at least one embodiment, the alert is a sound.

In at least one embodiment, a reference marker is provided at a predetermined location on the machine to orient the AR experience with respect to the machine.

In at least one embodiment, the reference marker is a barcode.

In at least one embodiment, the reference marker is a QR code.

In at least one embodiment, the reference marker is scanned and the augmented reality scene is mapped out in the device with respect to that reference point.

In at least one embodiment, the device is connected to the machine to allow it to control the machine.

In at least one embodiment, the device may stop the machine.

In at least one embodiment a plurality of devices may be used in conjunction with a single machine.

In at least one embodiment, the plurality of devices are provided with location information on the other devices.

In another embodiment multiple machines may be controlled from a single device.

### BRIEF DESCRIPTION OF THE DRAWINGS

The invention will be more clearly understood from the following description of an embodiment thereof, given by way of example only, with reference to the accompanying drawings, in which:

FIG. 1a is a first side view of a crusher, FIG. 1b is a second side view of the crusher and FIG. 1c is a plan view of the crusher;

FIG. 2 is a perspective view of another crusher;

FIG. 3 is a schematic diagram of an embodiment of a device in accordance with the present invention;

FIG. 4 is a schematic diagram of an AR headset connected to a machine;

FIG. 5 is a flow diagram which shows a first example of a computer implemented method in accordance with the present invention;

FIGS. 6a to 6c show, in schematic form an example of the use of a device of the present invention; and

FIG. 7 is a screen shot from the AR interface which shows an example of the use of a device in accordance with the present invention.

### DETAILED DESCRIPTION OF THE DRAWINGS

The present invention provides a device with an augmented reality interface which assists a user in identifying safe areas around a work machine. The device of the present invention may be implemented as an AR headset, or as a handheld device such as a rugged tablet computer.

The user's device can be connected directly to the machine or a remote service tablet via a wireless network connection such as Wi-Fi™, Bluetooth™, mesh network or alternatively connected to the machines telematics API through an internet connection (GSM, 3G, 4G, 5G etc).

The machine or remote service tablet may act as its own independent server to store the augmented reality content required to be displayed on the headwear. This independent server removes the need for an internet connection so the user can avail themselves of the experiences in an offline, remote geographic locations. Based on whether the machine is running or not, digital content is displayed on or around the machine to notify the user of “unseen” dangers. These notifications can be tailored to the location of the user relative to the machine.

The AR environment includes Environmental Health & Safety (EHS) prompts where applicable to inform/remind the user of all the associated hazards/dangers around the perimeter of the machine and upon or under it. It is known to list EHS warnings in the operators' manual and operating procedures documentation. However, by integrating them into an AR system in which this information is combined with real time video of the machine, an extra level of context and understanding is provided. In at least one embodiment, the device of the present invention compels a user to acknowledge that they have seen/read/listened to content before the user may proceed onto a subsequent piece of content. This feature also confirms that the user has accepted that they have understood the instruction.

The AR environment creates zones around the physical machine can be highlighted in different colours. These virtual components map on to the actual components of the machine to show which zones are safe around the machine. Arrows, warning symbols and audio prompts can also be used to provide safety guidance to a user around the machine and notify the user of any dangers as they move around the machine. The handheld device solution has arrows, voice commands and other symbols incorporated with real time video of the machine. The AR headset allows the user to look straight at the machine when viewing the AR content.

Positional awareness of the device may be provided by a grid/mesh network of invisible gaming objects positioned a set distance away from the machine. If the user collides with one of these gaming objects then a notification can be displayed on the device and a signal sent to the machine. The machine upon receipt of this information, checks the status of the machine to determine whether it is in operation, e.g. tracking, crushing/screening. Based upon that status, the machine can then trigger another event, such as stop machine from moving (if tracking), stop a belt and crusher/screen (if crushing/screening) or allow user to proceed towards the machine, if it is not functioning.

In addition to the above, the user will also have the ability to remotely stop the machine at any point directly from the headwear/handheld device if the user is within the immediate vicinity of the machine. This drastically cuts down the time for the user to reach for the nearest E-stop on the machine, especially if the user is away from the machine when the alert is raised and had to put themselves in potential danger by going up to the machine to stop it.

Multiple users may share the same experience. This means that if more than one user is in the vicinity of the machine then the other user could be notified of their whereabouts/location. For example, if the second user/device was at the other side of the machine and not in the first users line of sight.

This could also include if the other user/device was in a machine and they were moving into the area the first user is in. The user in danger could then be notified through an alarm or visual of the immediate risk and told to exit that area to avoid coming into harm.

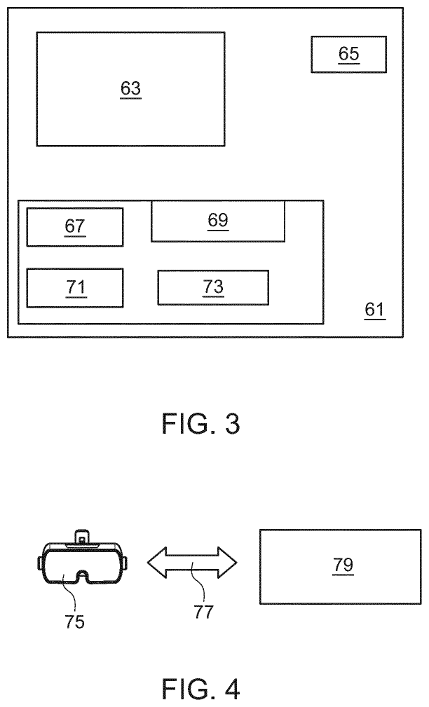

FIG. 3 is a schematic diagram which shows an example of a device in accordance with the present invention. The device 61 comprises a user interface 63, which may be a graphical user interface and an audio output on a tablet computer or may be an augmented reality environment, for example as may be provided using Microsoft HoloLens™ or similar device. The device also has a camera 65 which is used to capture as video, the surroundings of the device and in particular, the machine which requires maintenance. In at least one embodiment of the present invention, where bandwidth and location allows, video may be streamed and real time remote support provided.

The device uses positioning module 67 which determines the position of the device relative to the machine and which may use a reference marker such as a QR code as a reference marker to orient the device relative to the machine. Shape recognition module 69 is used to recognise the actual component of the machine in the video. The database of safe areas 73 provides a graphical representation displayable in the augmented reality scene. Matching module 71 matches a location in a safe area to the corresponding actual area around or on the work machine. FIG. 4 shows the device embodied as a AR headset 75 which is connectable 77 to the machine 79, via a Wi-Fi link.

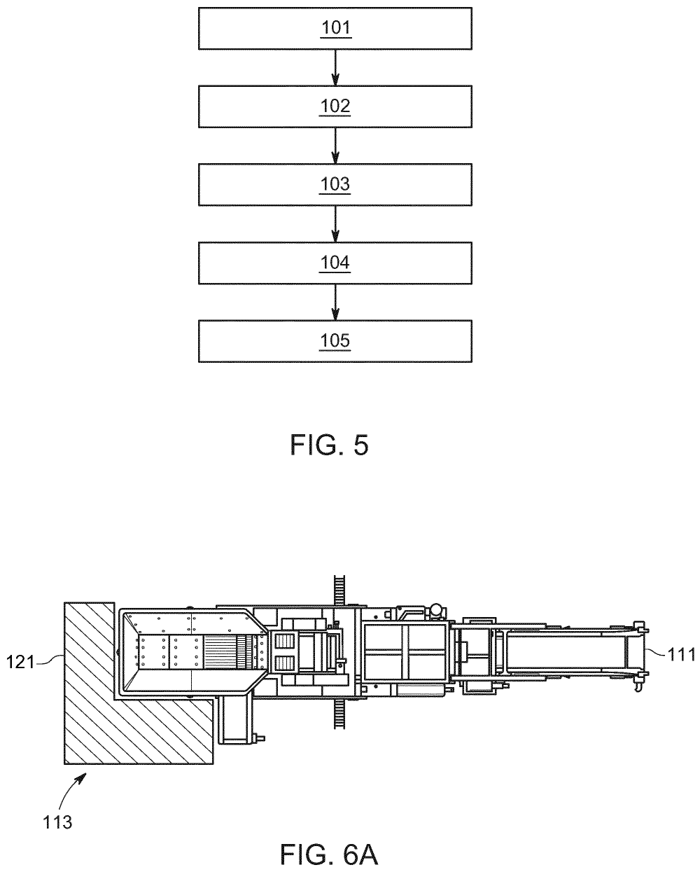

FIG. 5 shows an example of the method for assisting with the safe use or work machines, the method comprises, capturing, in real time, a video of an area of interest for inclusion in an augmented reality scene on a user interface of the device 101, determining the position of the device relative to the machine 102

recognising an actual component of the machine in the video 103;

accessing a database of virtual safe areas which are displayable in the augmented reality scene 104; matching the virtual component to the corresponding actual component to show a user in the augmented reality scene, areas around the machine which are safe and corresponding areas which are unsafe 105.

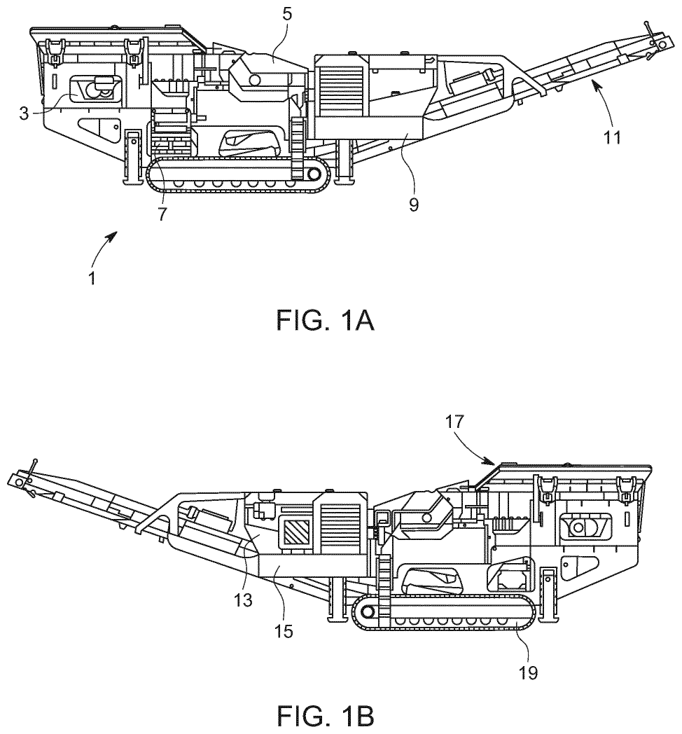

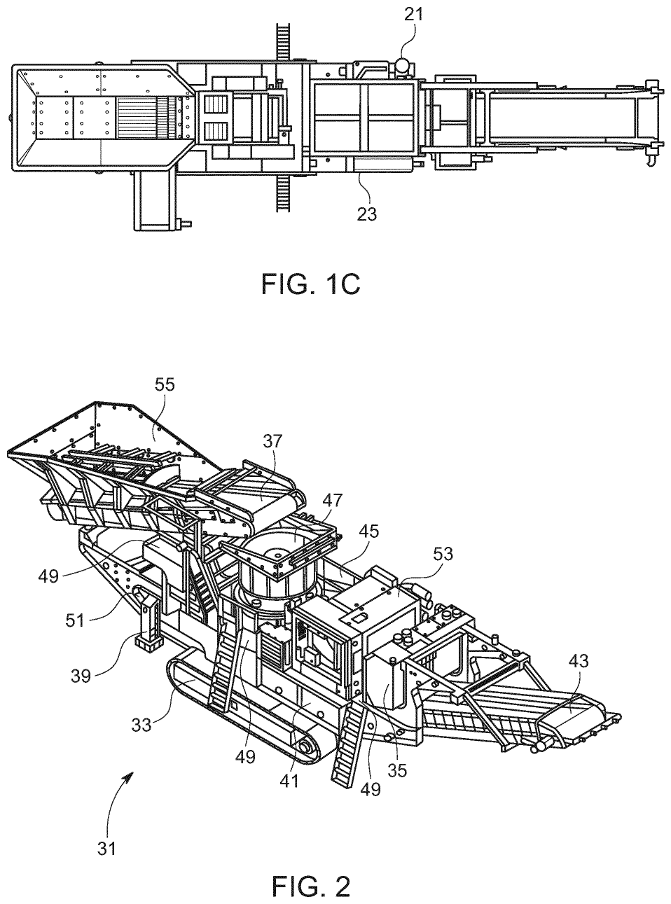

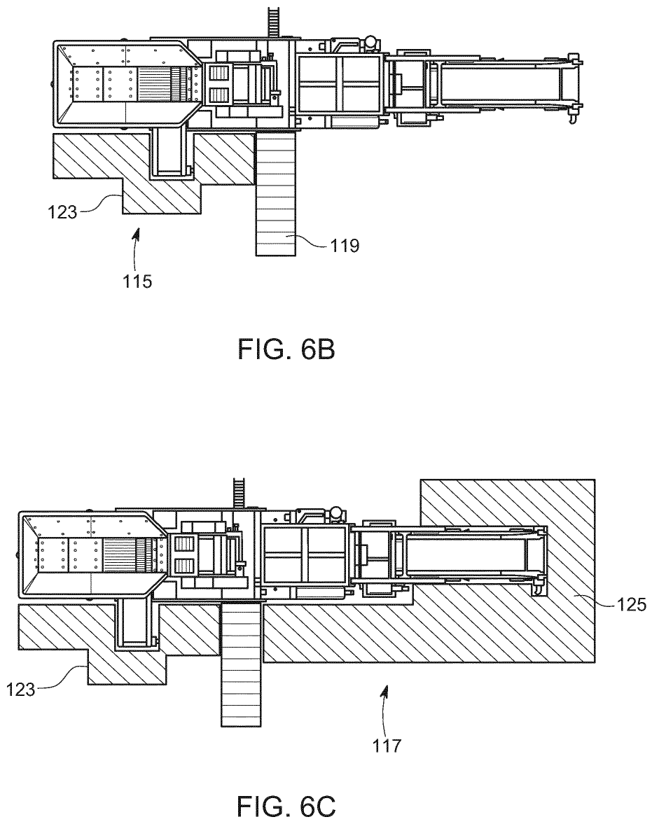

FIGS. 6a to 6c show, in schematic form, the operation of an example of a device in accordance with the present invention. These figures show a work machine 111 as described with reference to FIGS. 1a to 1c. In this example of the present invention, the device is an AR headset, the position of which, relative to the machine is shown by the stars 113, 115 and 117 in FIGS. 6a to 6c respectively. FIGS. 6a to 6c also show the position of the danger zones as viewed by a user through the device when in positions 113, 115 and 117.

In FIG. 6a, a user has switched on and is wearing an AR headset. The AR Headset camera takes video of the scene as viewed through the camera which contains machine 111. The AR headset determines its position with respect to the machine and accesses a database of safety information, which matches the scene in the video with VR graphical objects which show the danger zone 121 overlaid on the video of the machine.

FIG. 6b shows the user and device having moved to position 115, the camera on the headset now shows a different view of the machine 111 to the user. The AR headset determines its position with respect to the machine and accesses a database of safety information, which matches the scene in the video with VR graphical objects which show the danger zones 123 and 125 and safe zone 119 overlaid on the video of the machine.

FIG. 6b shows the user and device having moved to position 117, the camera on the headset now shows a different view of the machine 111 to the user. The AR headset determines its position with respect to the machine and accesses a database of safety information, which matches the scene in the video with VR graphical objects which show the danger zones 123 and 125 and safe zone 119 overlaid on the video of the machine.

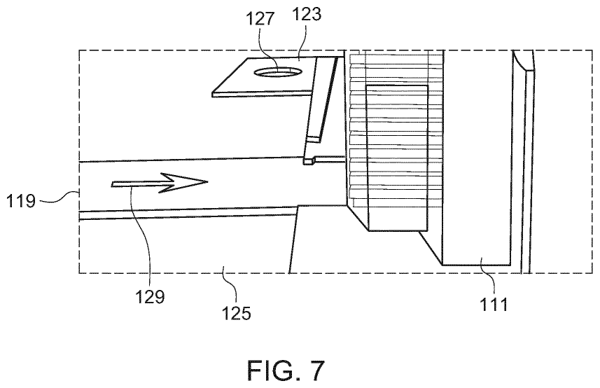

FIG. 7 is a screen shot from an AR headset graphical user interface which shows safe zone 119, danger zones 123, 125 and a danger sign 127. The danger sign will be appropriate to the circumstances and in this example is of a standard, well recognized type. The user interface may also contain audio and visual messages and alerts which inform the user when they have strayed into a danger zone. 129 is a guidance arrow for safe navigation around the machine, as shown in FIG. 7. The present invention may also include a library of signs, arrows and the like which represent the standard hazards, prohibitions and mandatory actions to the user.

The description of the invention including that which describes examples of the invention with reference to the drawings may comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a memory stick or hard disk. The carrier may be an electrical or optical signal which may be transmitted via an electrical or an optical cable or by radio or other means.

The description of the invention including that which describes examples of the invention describes the use of an augmented reality (AR) systems and apparatus.

AR overlays virtual objects onto the real-world environment. AR devices like the Microsoft HoloLens and various enterprise-level “smart glasses” are transparent, letting you see everything in front of you as if you are wearing a weak pair of sunglasses. The technology is designed for completely free movement while projecting images over whatever you look at. The term mixed reality overlays and anchors virtual objects to the real world.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A device for assisting with the safe use of a machine, the device comprising:
a user interface for displaying an augmented reality scene;
a camera for capturing in real time, video of an area of interest for inclusion in an augmented reality scene;
a positioning module for determining a position of the device relative to the machine;
a shape recognition module for recognizing an actual location near the machine in the video;
a database of virtual safe areas around the machine which are displayable in the augmented reality scene;
a matching module for matching the virtual safe areas to a corresponding actual component, to identify to a user, in the augmented reality scene, areas around the machine which are safe and corresponding areas which are unsafe.

2. The device as claimed in claim 1, wherein sensors determine an active status of the machine and the safety of a zone is determined depending on whether the zone is in or near an area where the machine is inactive or active.

3. The device as claimed in claim 1, wherein a reference marker is provided at a predetermined location on the machine to orient the device with respect to the machine, and wherein the machine is paired with the device using a near field communication system that detects if the device is in the vicinity of the machine and then instructs the user to look at the machine or scan the reference marker before proceeding.

4. The device as claimed in claim 1, wherein the device is a handheld device.

5. The device as claimed in claim 3, wherein the handheld device is a tablet computer or smartphone.

6. The device as claimed in claim 1, wherein the device is an augmented reality headset.

7. The device as claimed in claim 1, wherein the user interface is a graphical user interface and/or an audio output.

8. The device as claimed in claim 4, wherein the user interface is a graphical user interface that is controlled by physical interaction with the handheld device.

9. The device as claimed in claim 8, wherein the physical interaction includes gestures and/or voice and/or a keyboard and/or mouse which interact with objects in an augmented reality environment.

10. The device as claimed in claim 8, wherein the graphical user interface includes an augmented reality experience or a gaming object and animation combined with instruction windows.

11. The device as claimed in claim 1, wherein the positioning module includes a GPS location device.

12. The device as claimed in claim 1, wherein the positioning module includes a local network device which determines the position of the device with respect to nodes in a local network.

13. The device as claimed in claim 12, wherein the positioning module includes a combination of GPS and the local network.

14. The device as claimed in claim 1, wherein the positioning module uses a grid/mesh network of gaming objects positioned a set distance away from the machine.

15. The device as claimed in claim 1, wherein the positioning module defines an area relative to the machine and detects when the device has moved into/out of an area corresponding to a virtual safe area.

16. The device as claimed in claim 1, wherein the positioning module provides updated device position information to allow the augmented reality scene to reflect a change of location of the device with respect to the machine.

17. The device as claimed in claim 1, wherein the matching module indicates matching by an alert on the user interface.

18. The device as claimed in claim 17, wherein the alert is a flashing virtual area.

19. The device as claimed in claim 17, wherein the alert is a change in color of the virtual area.

20. The device as claimed in claim 17, wherein the alert is a sound.

21. The device as claimed in claim 1, wherein a reference marker is provided at a predetermined location on the machine to orient the device with respect to the machine.

22. The device as claimed in claim 21, wherein the reference marker is a barcode.

23. The device as claimed in claim 21, wherein the reference marker is a QR code

24. The device as claimed in claim 21, wherein the reference marker is scanned and the augmented reality scene is mapped out on the user interface with respect to that reference point.

25. The device as claimed in claim 1, wherein a plurality of devices are used in conjunction with a single machine.

26. The device as claimed in claim 23, wherein at least one of the plurality of devices is provided with location information on the other devices.

27. The device as claimed in claim 1, wherein multiple machines are controlled from a single device

28. A computer implemented method for assisting with the safe use of a work machine, the method comprising the steps of:
capturing, in real time, a video of an area of interest for inclusion in an augmented reality scene, on a user interface of the device;
determining a position of the device relative to the machine;
recognizing an actual area near the machine in the video;
accessing a database of virtual safe areas which are displayable in the augmented reality scene; and
matching the virtual safe areas to a corresponding actual area to show a user in the augmented reality scene, areas around the machine which are safe and corresponding areas, which are unsafe.

29. The method as claimed in claim 28 wherein sensors determine an active status of the machine and a safety of a zone is determined depending on whether the zone is in or near an area where the machine is inactive or active.

30. The method as claimed in claim 28, wherein a reference marker is provided at a predetermined location on the machine to orient the device with respect to the machine, and wherein the machine is paired with the device using a near field communication system that detects if the device is in the vicinity of the machine and then instructs the user to look at the machine or scan the reference marker before proceeding.

31. The method as claimed in claim 28, wherein the user interface is a graphical user interface which is controlled by gestures which interact with objects in an augmented reality environment.

32. The method as claimed in claim 28, wherein the step of determining the position of the device relative to a machine uses GPS.

33. The method as claimed in claim 28, wherein the step of determining the position of the device relative to a machine uses the position of the device with respect to nodes in a local network.

34. The method as claimed in claim 28, wherein the step of determining the position of the device relative to a machine combines GPS and a local network.

35. The method as claimed in claim 28, wherein the step of determining the position of the device relative to a machine uses a grid/mesh network of invisible gaming objects positioned a set distance away from the machine.

36. The method as claimed in claim 28, wherein the step of determining the position of the device relative to the machine defines an area relative to the machine and detects when the device has moved out of the area.

37. The method as claimed in claim 36, wherein an alert is provided to the device if it moves out of the area.

38. The method as claimed in claim 28, wherein the step of determining the position of the device relative to the machine detects and plots the position of the device with respect to the machine.

39. The method as claimed in claim 28, wherein, in the step of determining the position of the device relative to a machine, the device position information is updated to allow the augmented reality scene to reflect a change of location of the device with respect to the machine.

40. The method as claimed in claim 28, wherein a camera captures video of the area of interest for inclusion in the augmented reality scene, and wherein a virtual component is overlaid with an actual component image received from the camera.

41. The method as claimed in claim 28, wherein matching is indicated by an alert on the user interface.

42. The method as claimed in claim 41, wherein the alert is a flashing virtual area.

43. The method as claimed in claim 41, wherein the alert is a change in color of the virtual area.

44. The method as claimed in claim 41, wherein the alert is a sound.

45. The method as claimed in claim 31, wherein the graphical user interface includes an augmented reality experience, and wherein a reference marker is provided at a predetermined location on the machine to orient the augmented reality experience with respect to the machine.

46. The method as claimed in claim 45, wherein the reference marker is scanned and the augmented reality scene is mapped out in the device with respect to the reference point.

47. The method as claimed in claim 28, wherein the user is compelled to acknowledge that they have seen/read/listened to content before the user may proceed onto a subsequent piece of content.
